(19) United States
(12) Patent Application Publication
(10) Pub. No.: US 2003/0221535 A1
(43) Pub. Date: Dec. 4, 2003

(54) Structure and method for cutting slabs of natural cheeses into shape (s) via cutting blades of a pattern such that the shape (s) are tessellated or nested

(75) Inventors: Gerald L. Kraus, Plymouth, WI (US); Karl L. Linck, Kohler, WI (US); Aaron L. Strand, Plymouth, WI (US)

Correspondence Address: RYAN KROMHOLZ & MANION, S.C., Post Office Box 26618, MILWAUKEE, WI, 53226, US

(73) Assignee: Sargento Foods Inc.

(21) Appl. No.: 10/405,106

(22) Filed: Apr. 1, 2003

Related U.S. Application Data
(60) Provisional application No. 60/369,139, filed on Apr. 1, 2002.

(51) Int. Cl. B26F 1/14

(52) U.S. Cl. 83/686; 83/932

(57) ABSTRACT

A process and system for cutting of slabs of a target food product. The slabs produced by this cutting step are within a predetermined size range, i.e., predetermined range as to height, length, and width. After a slab of target food product is cut so that it is of a size that is within the predetermined boundary of the predetermined size range it is introduced to a cutting tool at a predetermined time and at a predetermined speed. The cutting tool is of a predetermined size and includes at least one cutting area that is at least sufficient to cut a predetermined pattern of tessellated or nested figures out of the slab of food product.

### RELATED APPLICATION

This patent application claims the benefit of U.S. Provisional Application No. 60/369,139, filed on Apr. 1, 2002.

### BACKGROUND OF THE INVENTION

This invention relates generally to the field of cutting patterns out of materials, and specifically to the cutting of nested, mosaic, or tessellated patterns from a slab or block of food product, e.g., cheese.

It is commercially desirable to provide food products in a variety of shapes that are appealing to consumers, e.g., cubes, stars, hearts, moons, various animals, various plants, various representations of real people or fictional characters, various shapes, various figures, etc. Typically, the production of such shapes and designs produces a commercially undesirable level of waste product, sometimes referred to as trim or “fines.” It is the object of the present invention to provide for the production of such shapes through the use of specially designed tooling to provide a system, by which such food products of various shapes may be produced with little or no waste product, i.e., fines.

### SUMMARY OF THE INVENTION

The process and system of the present invention may include pre-cutting a target food product into slabs. The slabs produced by this initial cutting step are within a predetermined size range, i.e., predetermined range as to height, length, and width. After a slab of target food product is cut so that it is of a size that is within the predetermined boundary of the predetermined size range it is introduced to a cutting tool at a predetermined time and at a predetermined speed.

A cutting tool according to the present invention is of a predetermined size and includes at least one cutting blade. The cutting blade preferably includes a cutting edge having a contour defining a shape that is at least sufficient to cut a predetermined pattern of tessellated or nested figures out of the slab of food product.

A preferred cutting tool may be in the form of a flat die having a laterally extending lattice cutting blade capable of cutting a predetermined pattern, and may include a knockout block for removing the cut pieces from the die. Alternatively, the cutting tool may be in the form of a rotary cutting tool having a radially extending lattice cutting blade capable of cutting a predetermined cutting pattern.

### DESCRIPTION OF THE DRAWINGS

FIG. 1 is a perspective view of the apparatus according to the present invention.

FIG. 2 is an exploded view of the apparatus shown in FIG. 1.

FIG. 2A is an enlarged, exploded view similar to that of FIG. 2, but particularly showing the die plate and knockout block.

FIG. 2B is an enlarged, fragmentary, exploded view with partial cross section of the portion of the die plate and knockout block shown generally in FIGS. 2A as 2B.

FIG. 3 is a fragmentary section view of the apparatus seen in FIGS. 1-2B, taken along line 3-3 of FIG. 1 and showing the die plate in the retracted position.

FIG. 3A is a fragmentary section view similar to that of FIG. 3, but showing the die plate in cutting position.

FIG. 4 is a side plan view of the apparatus shown in FIGS. 1-3, but showing the apparatus in conjunction with an optional cheese block cutting assembly.

FIG. 5 is a side plan view of the apparatus shown in FIGS. 1-4, and further showing a pre-sliced slab of food product in ready position relative the cutting area of the apparatus and prior to being cut into desired shapes.

FIG. 6 is a side plan view similar to FIG. 5, but showing the die plate lowered into cutting position relative to a slabbed food product.

FIG. 6A is an enlarged fragmentary perspective view of area 6A of FIG. 6.

FIG. 7 is a side plan view similar to those of FIGS. 5 and 6, but showing the die plate lifting from the cut food product and retracting into the knockout block, thereby forcing the cut food product from the die plate.

FIG. 8 is a side plan view similar to those of FIGS. 5-7, but showing the die plate in an optional, secondary, partially extended position.

FIG. 9 is a side plan view similar to those of FIGS. 5-8, but showing the die plate in a resting position and retracted into the knockout block.

FIG. 10 is a side plan view of an alternative method and structure of the present invention including discharge of the cut pieces of food product into the interior of a rotary cutting wheel and the use of pressurized air to remove the cut pieces of food product.

FIG. 11 is a perspective view of another alternative cutting tool design having removable or demountable cutting dies as well as open or non-cutting areas.

FIG. 12 is a side view of an alternative procedure and structure of the present invention.

FIG. 13 is a side plan view of another alternative structure and method of the present invention.

FIG. 14 is a perspective view of yet another alternative cutting tool arrangement including a tumbler and a feeder tube through which a predetermined material, such as a coating material, may be added to the cut pieces of food product.

FIGS. 15 through 25 disclose a variety of alternative cutting patterns into which a cutting edge may be formed and that may be employed to cut a food product with minimal or zero waste, with FIGS. 15A-15E illustrating views of a food product cut according to the cutting pattern of FIG. 15, by way of example.

### DETAILED DESCRIPTION

Although the disclosure hereof is detailed and exact to enable those skilled in the art to practice the invention, the physical embodiments herein disclosed merely exemplify the invention, which may be embodied in other specific structure. While the preferred embodiment has been described, the details may be changed without departing from the invention, which is defined by the claims.

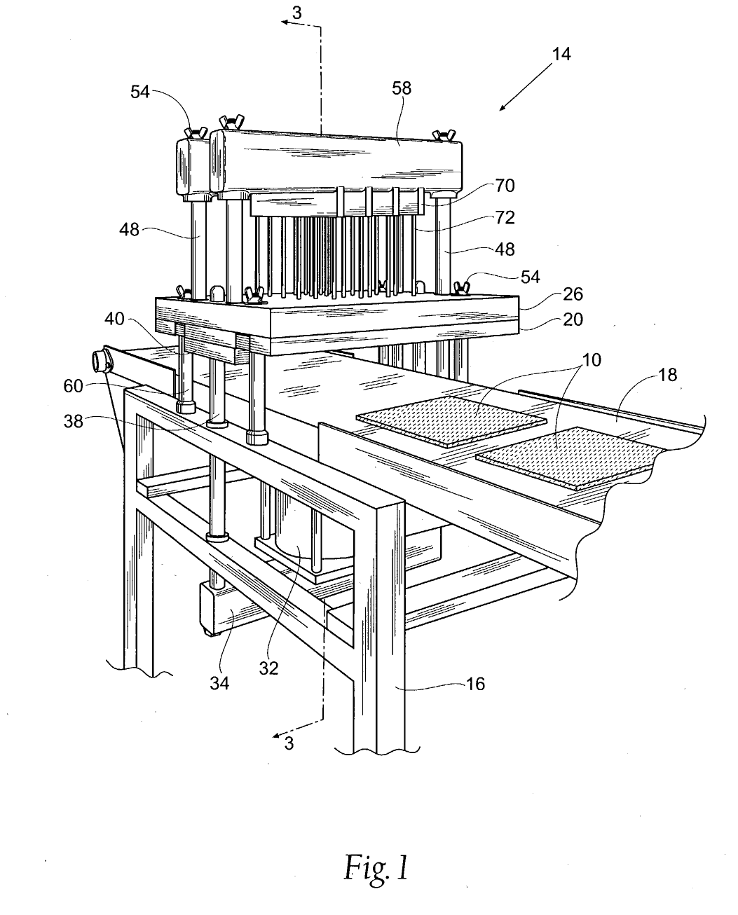

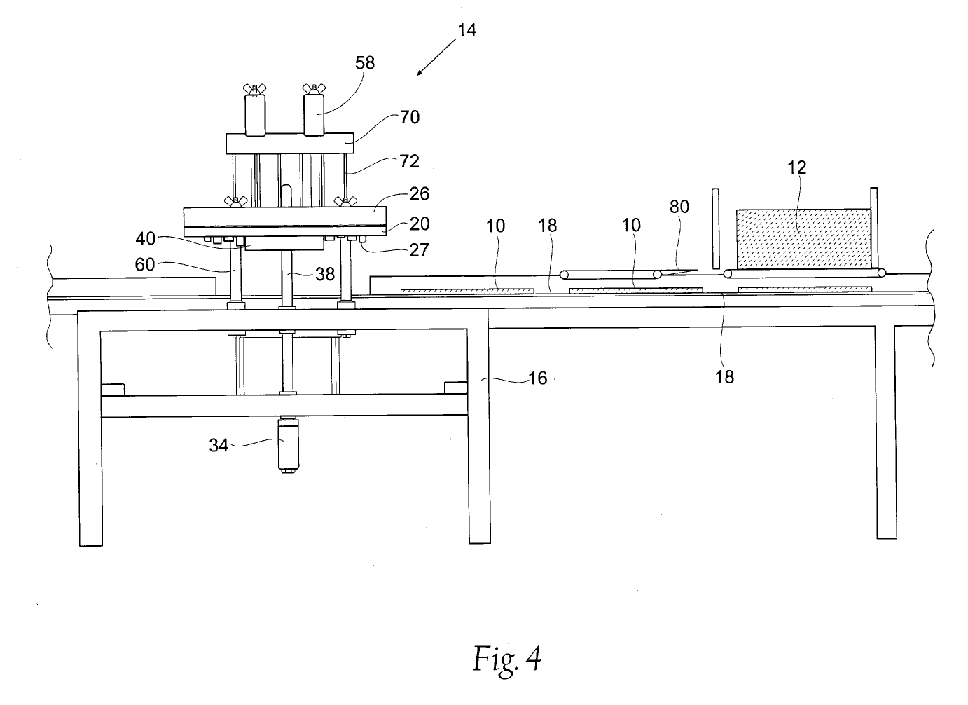

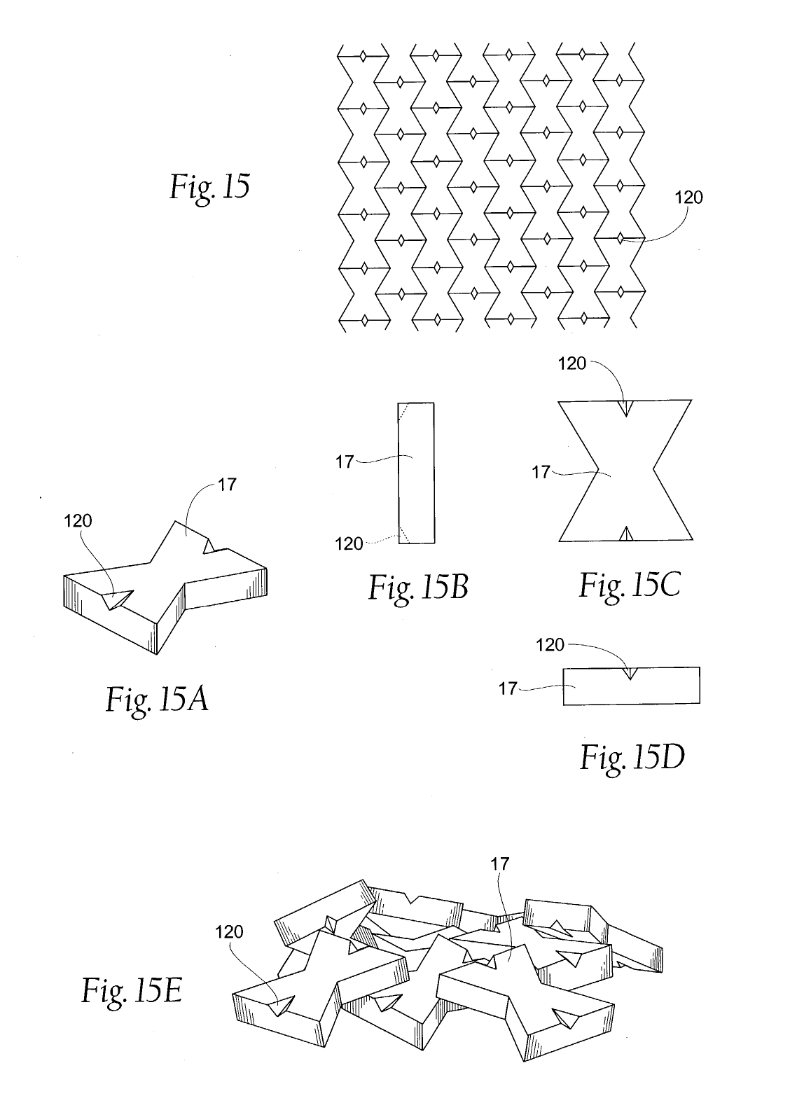

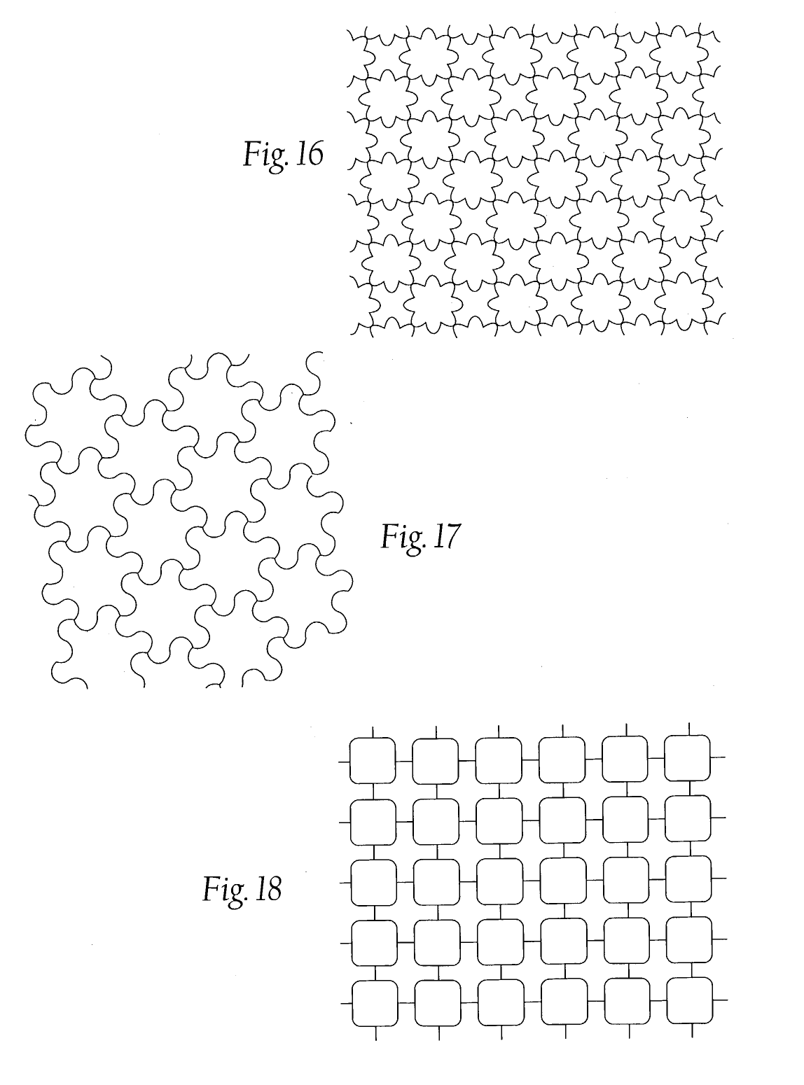

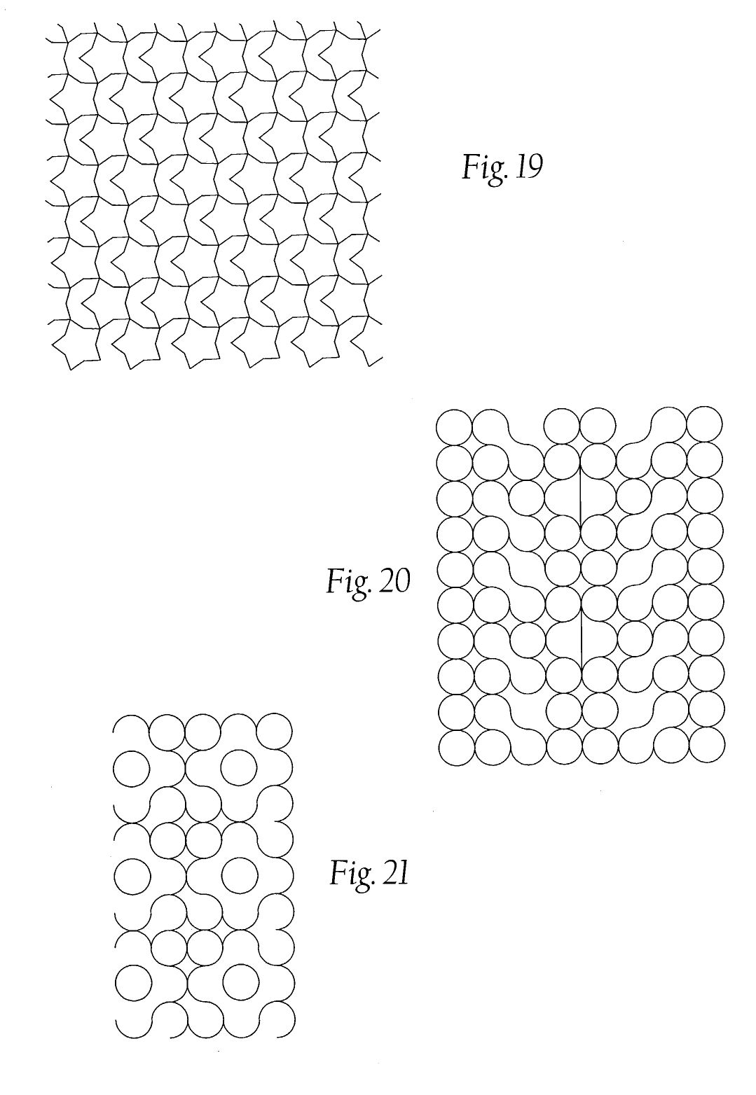

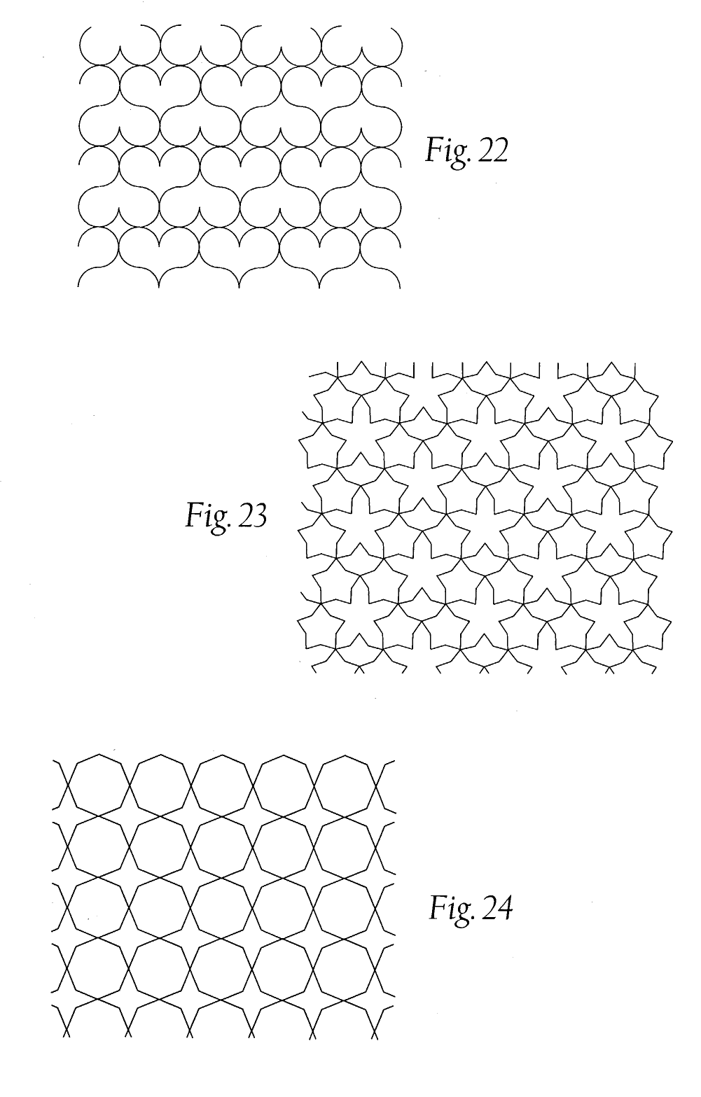

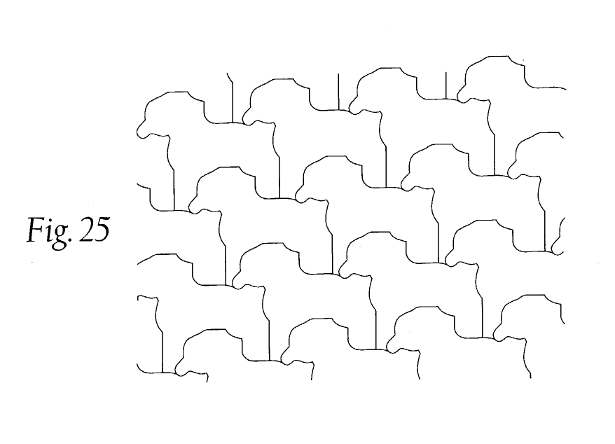

The invention may be practiced as illustrated in the Figures. With particular reference to FIGS. 1-9 the structure and method of a preferred embodiment of the present invention may be seen. As seen particularly in FIGS. 4-9, slabs 10 of a food product 12, such as cheese, are pre-positioned and ready for introduction to a cutting die 20, having a predetermined cutting pattern. The predetermined pattern configured of the die 20 is capable of cutting or stamping an introduced slab 10 of predetermined thickness into tessellated or nested figures of food product. See, e.g., FIGS. 15-26, which show some suggested types of cutting patterns that could, without limitation, be used.

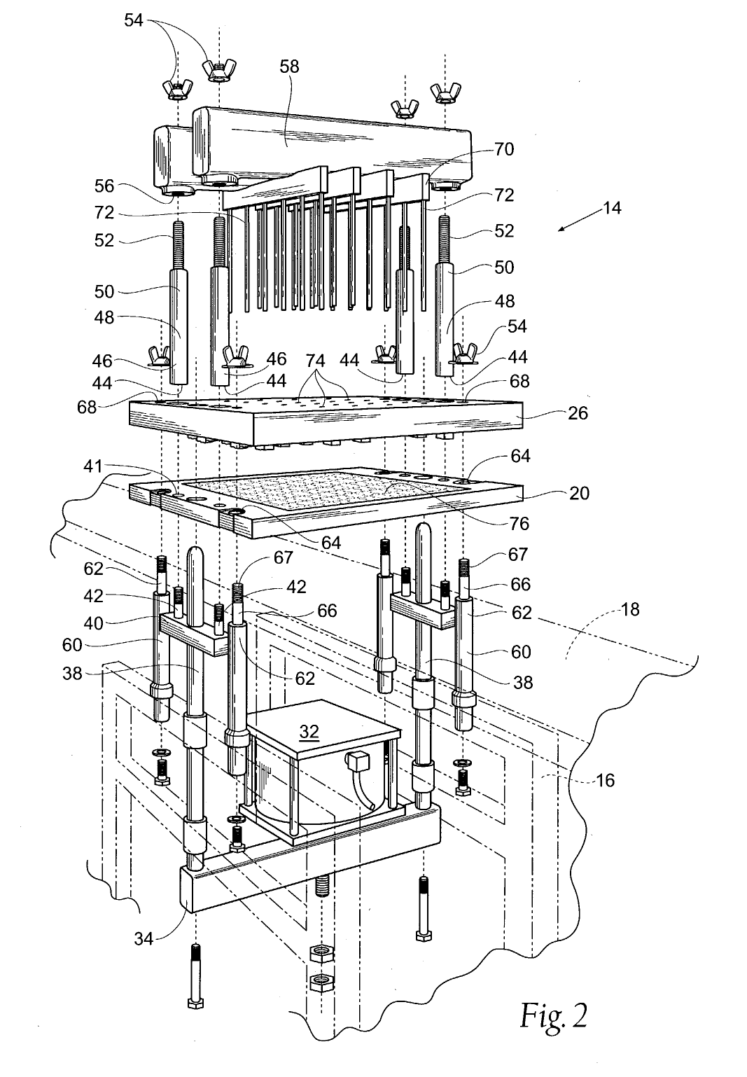

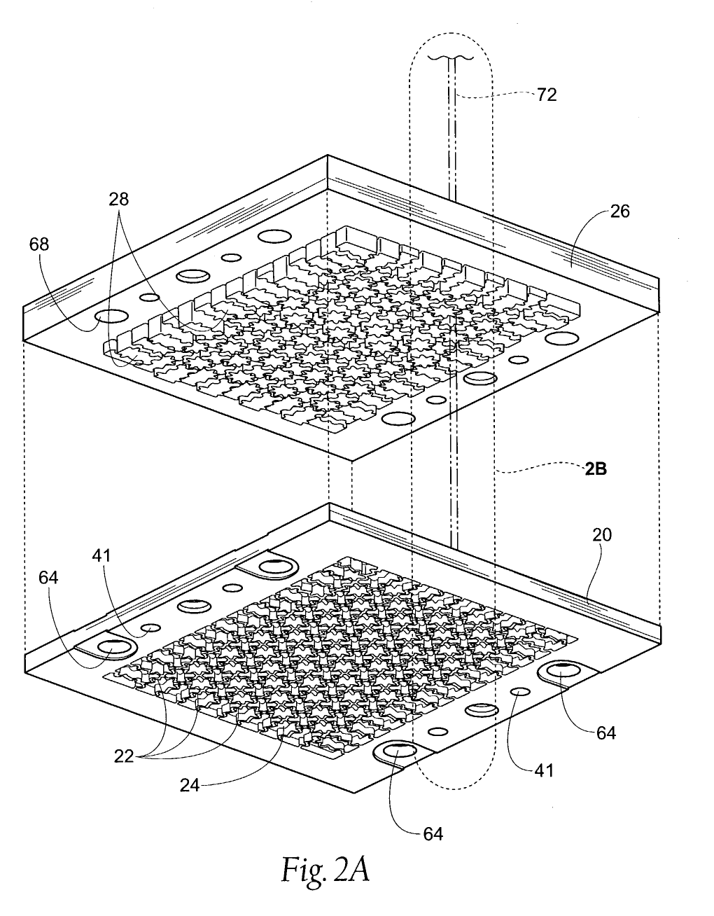

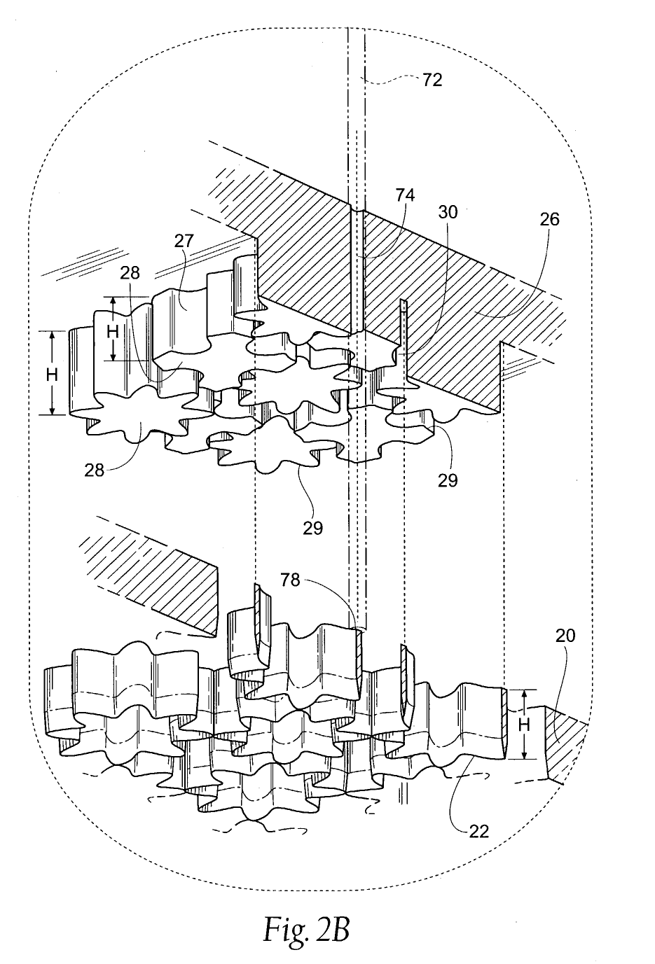

As shown in FIGS. 1-2B, inclusive, an apparatus 14 according to the present invention may be seen. The apparatus 14 as shown is a press type cutter and preferably utilizes a vertical motion to cut slabs 10 of food product 12 (see FIG. 4). The apparatus 14 preferably includes a support workstation 16 for supporting feeder means, seen herein as a belt-type conveyer 18 and other apparatus components as will hereinafter be described. The apparatus 14 further preferably includes a planar cutting die 20 having a plurality of laterally extending cutting knives 22 (see FIGS. 2A and 2B). The cutting knives 22 are preferably arranged in a predetermined latticed cutting pattern 24 corresponding to the shape of food desired. Since a desired goal of the present invention is to minimize waste, such as trim or “fines” during a cutting procedure, a latticed cutting pattern 24 according to the present invention preferably includes a nested or tessellated configuration.

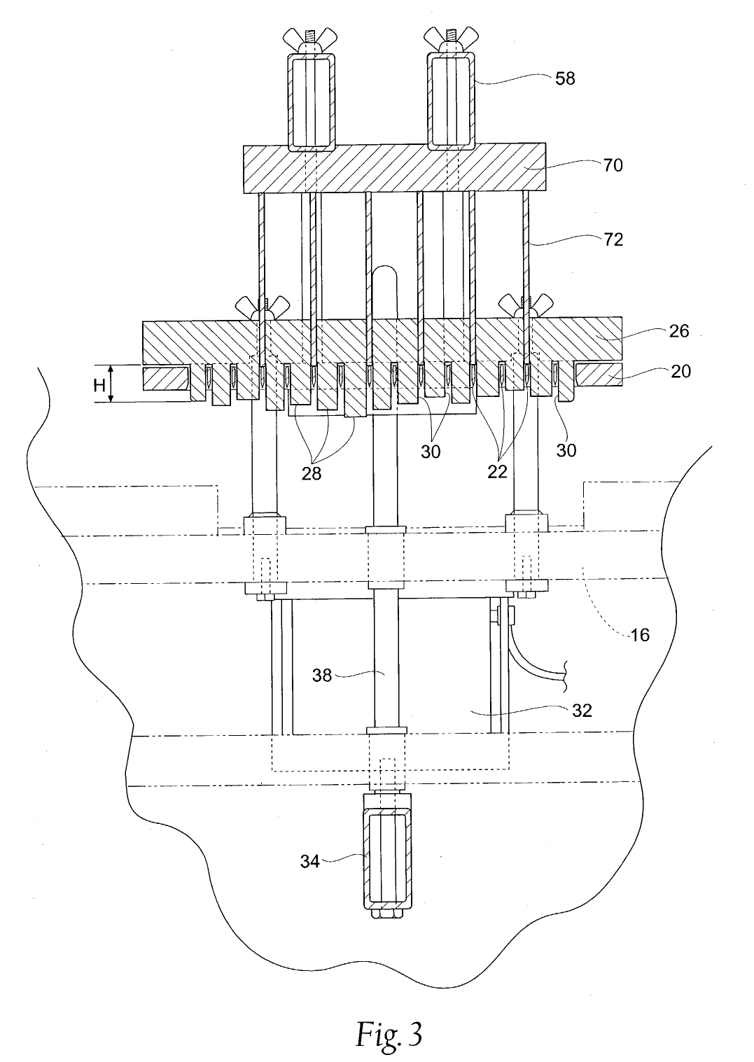

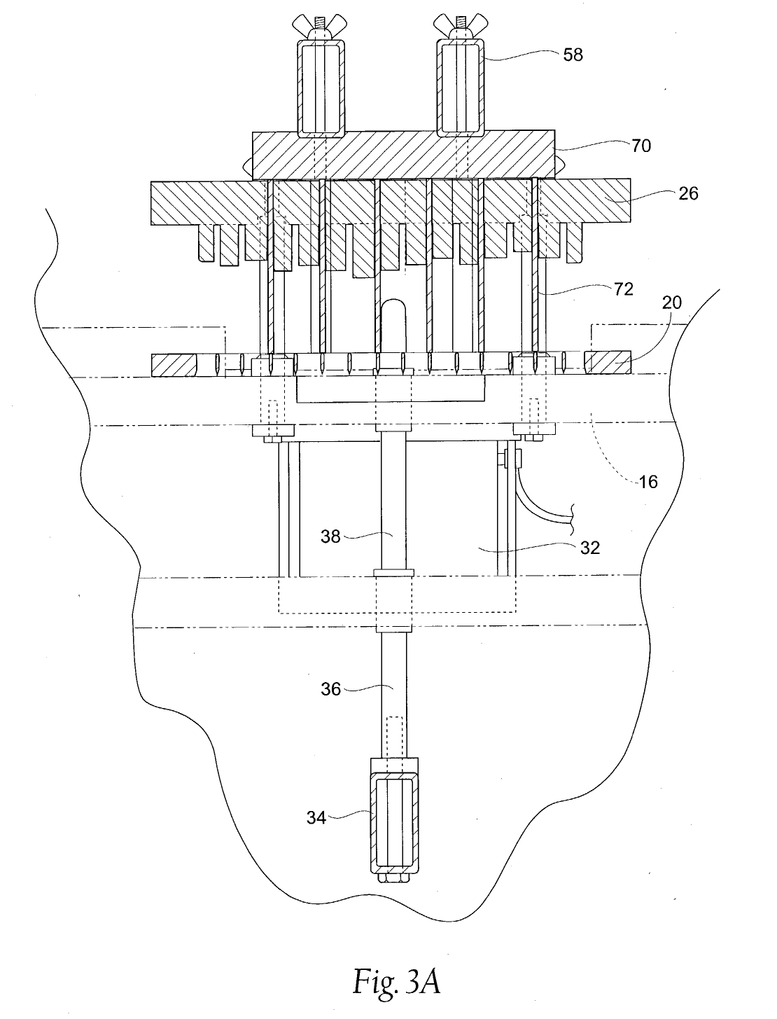

Seen particularly in FIGS. 2 through 2B, the apparatus 14 may further include a knockout block 26. The knockout block 26 is arranged to knock out the individual cut food products 17 (depicted in FIG. 7) from the cutting die 20 after the slab 10 of food product 12 has been cut. To accomplish this task, and as seen particularly in FIG. 2B, the knockout block 26 preferably includes a plurality of downwardly protruding knockout shapes 27 each having a knockout surface 28. The knockout surfaces 28 each define a predetermined perimeter 29. The perimeter 29 of each knockout surface 28 preferably adjoins and defines a re-entrant channel 30. The channels 30 form an interlocking pattern, which preferably corresponds to the predetermined cutting pattern 24 of the cutting knives 22. As seen particularly in FIG. 3, this arrangement allows the cutting knives 22 to retract into the respective channels 30 of the stationary knockout block 26 when withdrawn between cutting actions. Further, and as seen in FIG. 7, the knockout surfaces 28 are adapted to urge the cut food product from the cutting die 20 after cutting. It is to be understood that while the various Figures depict knockout surfaces 28 that correspond to the shape of the desired, finished food shape, other knockout surface configurations may be envisioned. Minimally, the knockout surfaces 28 are of at least a shape and size able to fit inside a respective knife shape profile, thereby knocking out the cut food 17 from within the knife perimeter, which perimeter will hereinafter be described and discussed. Further, the knockout surfaces 28 may be optionally provided with a raised or countersunk surface (not shown), to thereby allow for embossing, stamping, or imprinting the cut food 17. An example of a cut food 17 having an embossed portion 120 may be seen in FIGS. 15-15E, by way of example.

As may be seen particularly in FIGS. 2A and 2B, the individual knockout shapes 29 are preferably of a predetermined height H. The predetermined height H may be of any acceptable height, but is preferably of a height at least corresponding to the height H of the cutting knives 22. In particular, as seen in FIG. 3, the individual heights H of each knockout shape 27 may vary in the staggered pattern shown. A staggered height pattern provides a more even force distribution across the cutting die 20 when the cut food product 17 is forced from the cutting die 20 after cutting (see FIG. 7), and thereby having a greater efficiency of design.

Referring now to FIGS. 1-3, the various components of a preferred apparatus 14 according to the present invention may be seen. As mentioned earlier, the apparatus 14 preferably includes a support workstation 16. A prime mover, seen as an air operated cylinder and piston 32 is supported by the workstation 16. While the various Figures depict an air operated cylinder and piston 32 as the prime mover, it is within the province if the present invention to use other prime movers, such as solenoids, linear servos, cams or other known means. A reciprocating, movable operating cross bar 34 is threadingly connected with an operating rod 36 extending from the prime mover (as detailed in FIG. 3A). The reciprocating, movable operating cross bar 34 is attached to at least one vertically operating traveling member 38, with two, oppositely disposed traveling members 38 being shown in the Figures. The vertically operating traveling member 38 further includes a secondary cross bar 40 having upwardly extending threaded studs 42. The threaded studs 42 are adapted to be received by through bores 41 located in the cutting die 20. The threaded studs 42 are further adapted to be received and threadingly seated in threaded apertures 44 formed in the lower ends 46 of a respective extension 48. The extensions 48 each include an upper end 50 having a threaded portion 52 to be threadingly received by manually operable wing nuts 54. Although other fastening means may be envisioned, wing nuts 54, as shown, are preferred for ease of breakdown and setup of new die and knockout combinations. The upper end 50 is further adapted to be received by a corresponding through bore 56 in an upper cross bar 58 and sufficiently extending to be threadingly received by manually operable wing nuts 54. While the Figures illustrate a pair of generally parallel cross bars 58 the invention may be practiced with other numbers of cross bars 58.

The workstation 16 further includes upright support posts 60. The support posts preferably each include an upper end portion 62 adapted to be slidingly received by through bore 64 of cutting die 20, a first upper portion 66 adapted to be received by through bore 68 in knockout block 26, and a second, threaded upper portion 67 to be threadingly received by wing nuts 54. This arrangement effectively secures the stationary knockout block 26 to the workstation, while allowing for vertical movement of the cutting die 20.

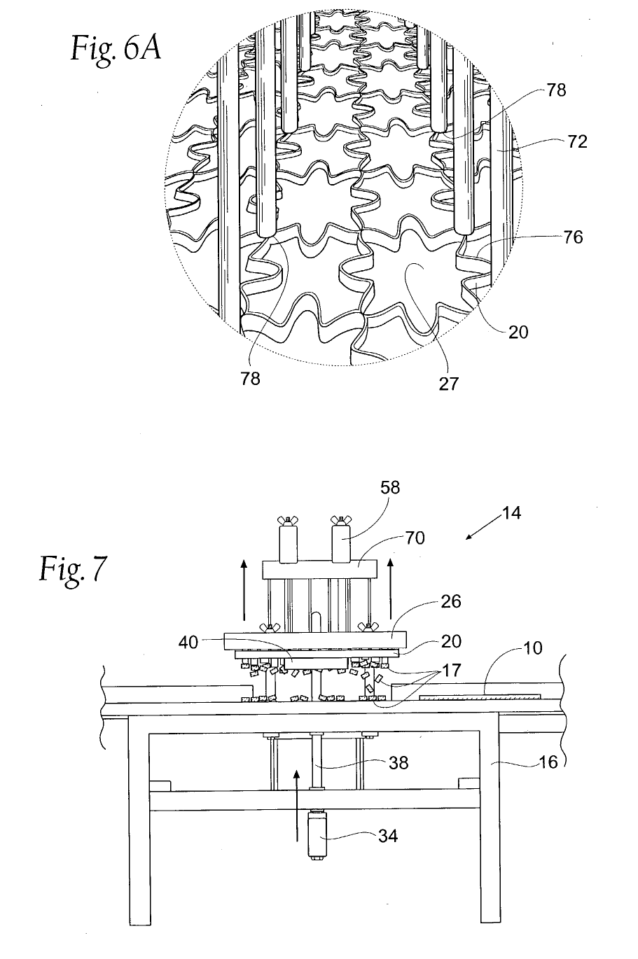

As may be seen in the Figures, the upper pair of parallel cross bars 58 further preferably includes transversely disposed supports 70, each of which include a plurality of downwardly extending rod members 72. The rod members 72 are slidably engaged by corresponding cooperating apertures 74 (seen particularly in FIG. 2B) in the stationary knockout block 26 and extend downwardly to rest upon the upper surface 76 of the cutting die 20. As may be seen particularly in FIG. 6A, the rod members 72 preferably rest upon the upper surface 76 at pre-selected intersections 78 of the lattice cutting pattern 24. The rod members 72 provide equal distribution of force throughout the top surface 76 of the cutting die 20 during the cutting process.

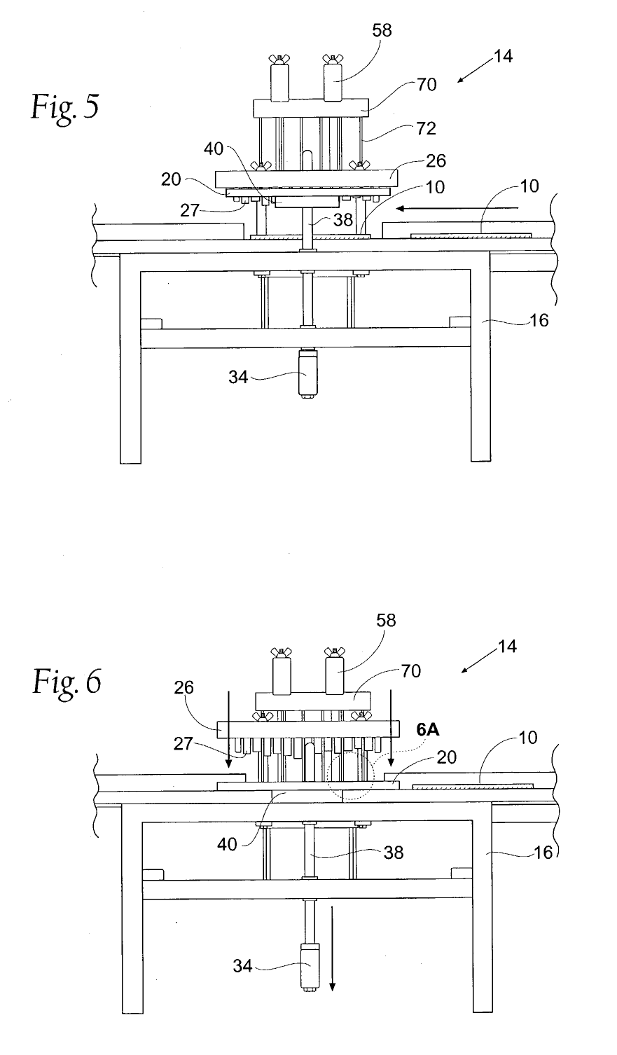

Referring now to FIGS. 4-9 the process and method of the present invention may be seen. As may be seen particularly in FIG. 4, slabs 10 of a food product 12, such as cheese, are introduced to a cutting die 20 having a predetermined cutting pattern 24 as discussed previously. The predetermined pattern 24 is capable of cutting an introduced slab 10 into tessellated or nested figures of food product. See, e.g., FIGS. 14-26, which show some suggested types of cutting patterns that could, without limitation, be used. As seen in FIG. 4, slab 10 may be sliced from a block 12 of cheese, or other acceptable food product, to a predetermined thickness by a slicing tool 80, as shown as part of the method, or may be precut prior to being introduced to the apparatus 14. The slab of food product 10 is moved by conveyor 18, as shown in the Figures, or by other means, to a position directly below a cutting die 20 (shown in FIG. 5). The piston of the prime mover 32 (not seen in this view) moves the operating cross bar 34 and vertical traveling member 38 and, as seen by the arrows in FIG. 6, thereby lowers the cutting die 20 toward the slab 10. The knives 22 of the cutting die 20 are thereby pressed into the slab 10. As seen in FIG. 7, as the cutting die 20 is retracted into the countersunk channel 30 of knockout block 26, the now cut food product 17 is urged from the cutting die 20 by the knockout surfaces 28 (described earlier with reference to FIG. 3).

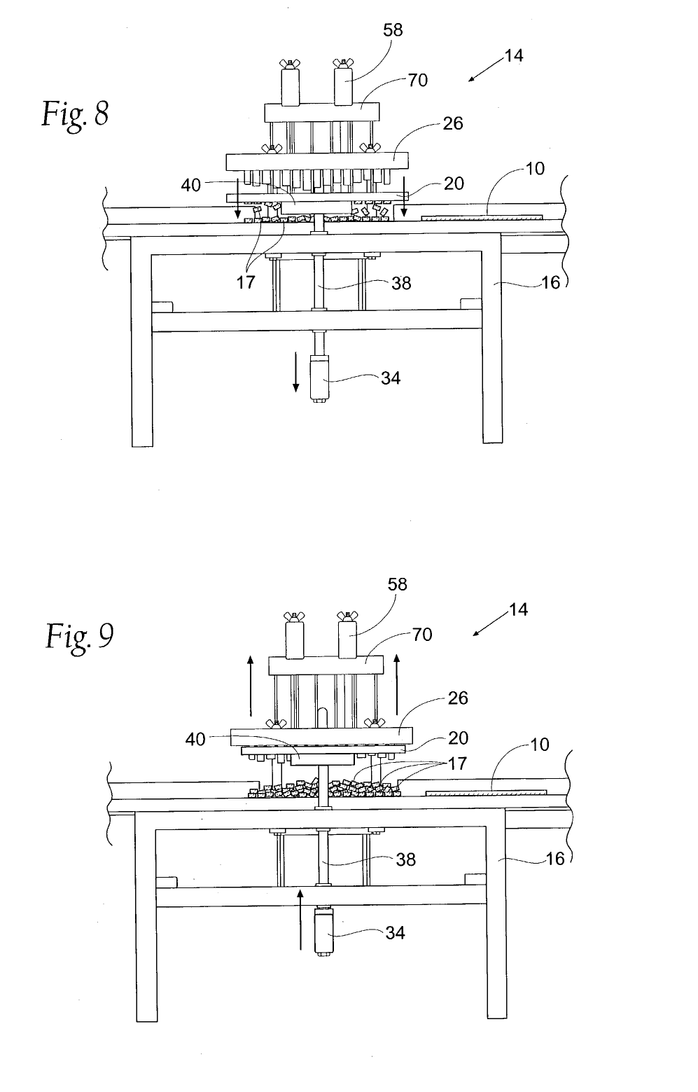

As may be seen in FIGS. 8 and 9, the method of the present invention may preferably further include the optional step of partially lowering the cutting die 20 after a first cut has been made, and retracting the cutting die 20 for a second time into the countersunk channel 30 of the knockout block 26. This optional step ensures removal of all cut food 17 from the cutting die 20 and knockout block 26 prior to cutting the next incoming slab 10.

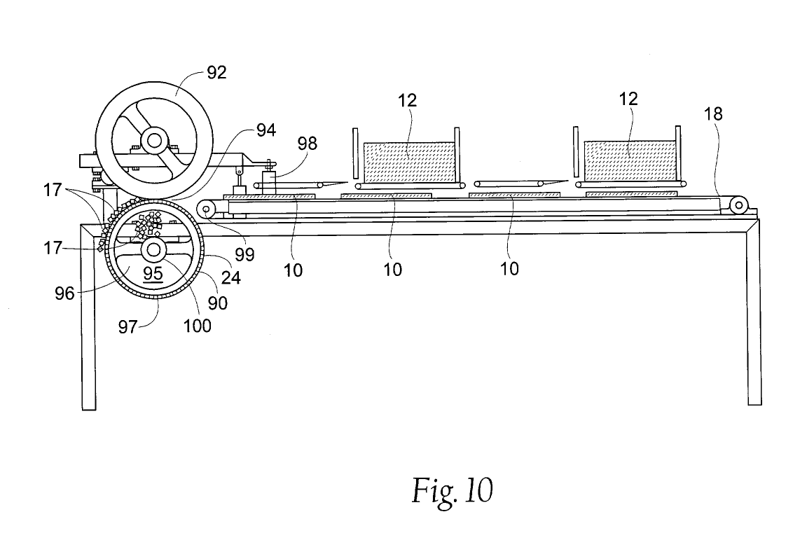

With attention to FIG. 10, an alternative embodiment cutting apparatus 90 may be seen. As shown, slabs 10 of a food product 12, such as cheese, are introduced to a rotary cutting die 90, having a predetermined cutting pattern 24 (See FIGS. 15-25, which show some suggested, non-inclusive types of cutting patterns that could be used), and a compression wheel 92. As is further seen, the slab 10 is fed into a pinch point 94. The compression wheel 92 forces the slab 10 into the cutting pattern 24 of the cutting wheel 90. Substantially, the entire slab 10 is cut into individual pieces 17 as determined by the cutting pattern 24 that is used; very little or no waste material, i.e., material that cannot now be packaged, is produced. The resulting cut pieces 17 may then either be allowed to fall into the interior 95 of the cutting wheel 90 and tumble out an end 96 or, alternatively, may be carried between the cutting blades 97 of the cutting pattern 24 and discharged tangentially at a later point in the rotation via any number of means such as gravity, centrifugal force, an automated plunger, application of compressed air, etc.

Similarly to the previously described embodiment, and to ensure that the cutting pattern 24 is in appropriate position, the cheese slabs 10 are advanced via a conveyor belt 18 that operates at a predetermined speed. As noted previously the cheese slabs 10 all fall within a predetermined size range. A sensor 98 may be used to ascertain the position of the cheese slab 10. An encoder 99 is preferably communicatively coupled to servomotors 100 that are operatively coupled to both the cutting wheel 90 and the compression wheel 92. The encoder 99 tells the servomotors 100 the speed of the belt 18 and thus the speed of the slab 10. The servomotors 100 then match the speed of the belt 18. The servomotors 100 are capable of adjusting the speed of the cutting wheel 90 and the compression wheel 92 to match the speed of the cheese slab 10. The cutting pattern 24 of the cutting wheel 90 is at a known starting position. The servomotors 100 preferably cause both the cutting wheel 90 and the compression wheel 92 to rotate at a speed that matches the speed of the slab 10 and at a time that cutting pattern 24 is in position to cut the slab 10. Alignment with both the compression wheel 92 and the cutting wheel 90 is preferably maintained by use of side belts (not shown). In this manner slab 10 after slab 10 may be cut and the resulting pieces 17 packaged.

A specific example of an alternative embodiment of the present invention may be seen in FIG. 11. The alternative embodiment shown may include a cutting wheel 90 comprised of first and second cutting sections 102 and first and second non-cutting sections 104. The first cutting section 102 will cut a particular pattern out of a first slab 10 of predetermined food product, such as cheese. The first non-cutting section 104 will sequentially follow the first cutting section 102 to allow for discharge of the now cut pieces 17 of the first slab 10 of cheese as well as separation from the subsequent type of cheese slab 10 entering the second cutting section 102. The non-cutting sections 104 allow the cut pieces 17 to fall through for packaging.

Another alternative embodiment may employ the use of a cutting wheel 90 having first and second cutting sections 102 in conjunction with a compression belt (not shown) instead of a compression wheel 92 as illustrated.

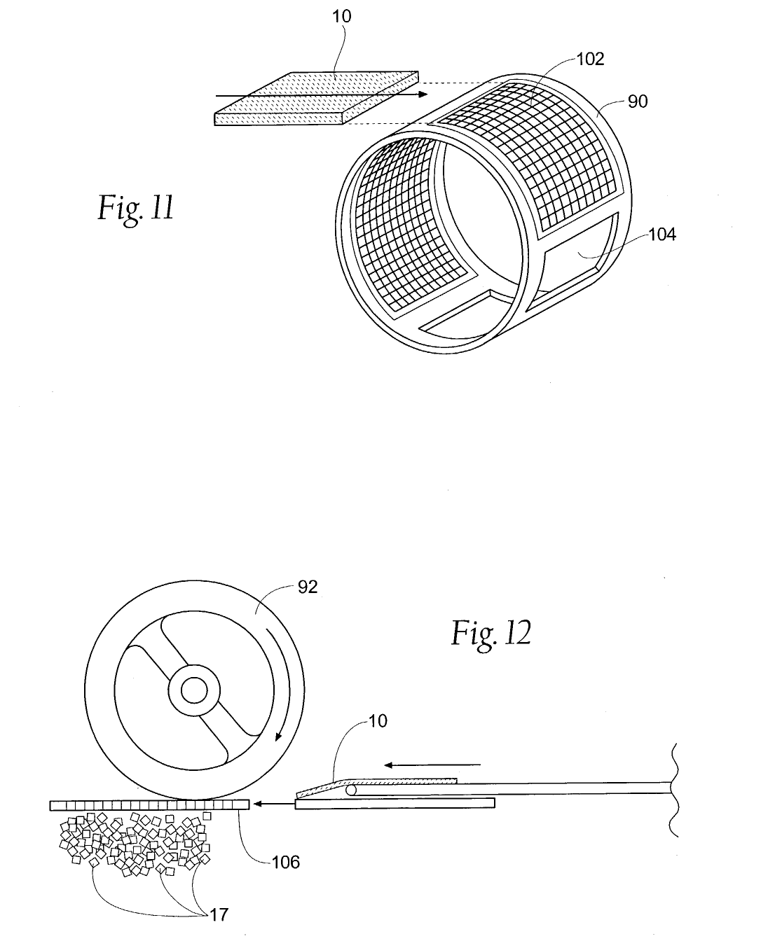

Alternatively, and as seen in FIG. 12, the cutting wheel 90 may be replaced by a reciprocating cutting plate 106 having a cutting pattern 24 (not shown). The cutting plate 106 preferably matches the, speed of the slab 10 advanced from belt 18 and slides the slab 10 under a compression wheel 92 whereby slab 10 would be forced onto and through cutting pattern 24 producing cut pieces 17 with minimal or no waste.

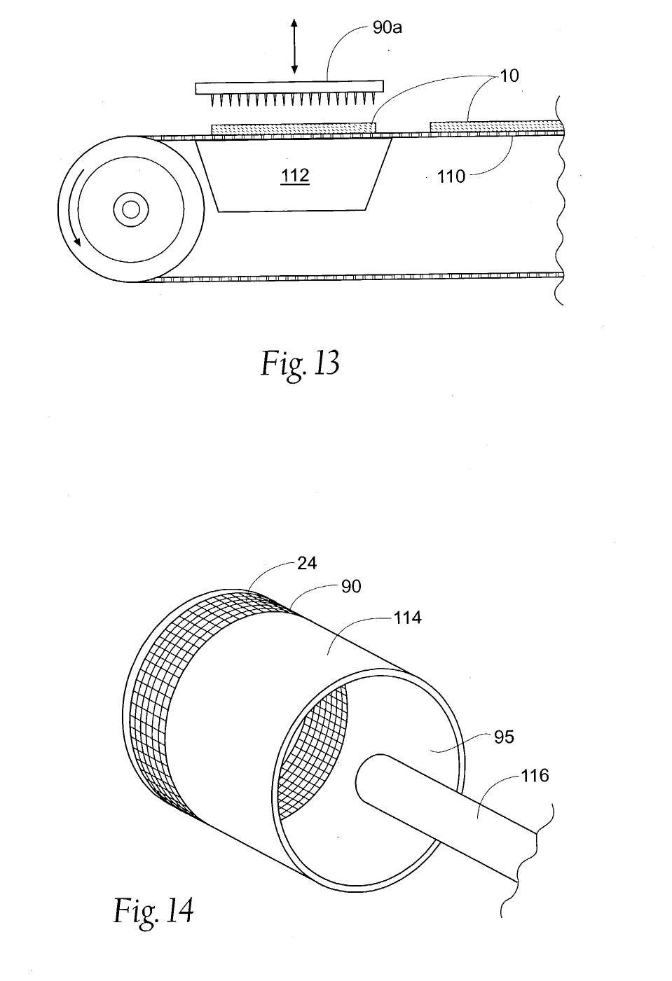

As seen in FIG. 13, a vented belt 110 may be substituted for belt 18 and a vacuum chamber 112 used to apply a negative pressure to hold the slab 10 down and against belt 110 during and after the application of a reciprocating cutting head 90a. Thereby holding the cut pieces 17 in place on the belt 110 until after they have been advanced past the reciprocating cutting head 90a.

Another arrangement may be seen in FIG. 14. Here, a rotary cutting tool 90 may include a cutting pattern portion 24 and a tumbler 114. The cut pieces (not shown in this view) are allowed to fall into the interior 95 of the tool 90 wherein a feeder 116 may introduce a coating such as an anti-caking agent, for example (not shown) to the cut pieces 17.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. An apparatus for cutting a slab of food product into a predetermined shape, said apparatus comprising:
a cutting die having a plurality of laterally extending knife blades, said knife blades each having a predetermined perimeter;
a first drive device arranged to move the cutting die to a cutting position;
a feed device arranged to feed a slab of food product to a cutting area in a feeding direction extending generally perpendicular to the laterally extending knife blades.

2. The apparatus of claim 1 further including a knockout block, said knockout block including a plurality of knockout shapes arranged to be received by the predetermined perimeter of said knife blades.

3. The apparatus of claim 2 wherein said knockout block further includes at least one countersunk channel, said countersunk channel arranged to slidably receive at least one of said plurality of knife blades.

4. The apparatus of claim 2 wherein said knockout shapes have a predetermined height and wherein said plurality of laterally extending knife blades have a predetermined height.

5. The apparatus of claim 4 wherein said predetermined height of said knockout shapes is randomly selected relative to the predetermined height of said plurality of said knife blades.

6. The apparatus of claim 1 wherein said predetermined perimeter of said knife blades defines a latticed, nested pattern.

7. The apparatus of claim 1 wherein said cutting die is a cutting wheel.

8. The apparatus of claim 2 wherein said plurality of knockout shapes each include a knockout surface, at least one knockout surface including at least one raised area.

9. The apparatus of claim 2 wherein said plurality of knockout shapes each include a knockout surface, at least one knockout surface including at least one countersunk area.

10. An apparatus for cutting a slab of food product into a predetermined shape, said apparatus comprising:
a cutting die having a plurality of laterally extending knife blades, said knife blades each having a predetermined perimeter;
a first drive device arranged to move the cutting die from a first, raised, position to a second, cutting, position;
a feed device arranged to feed a slab of food product to a cutting area in a feeding direction extending generally perpendicular to the laterally extending knife blades.

11. The apparatus of claim 10 further including a knockout block, said knockout block including a plurality of knockout shapes arranged to be received by the predetermined perimeter of said knife blades.

12. The apparatus of claim 11 wherein said knockout block further includes at least one countersunk channel, said countersunk channel arranged to slidably receive at least one of said plurality of knife blades.

13. The apparatus of claim 11 wherein said knockout shapes have a predetermined height and wherein said plurality of laterally extending knife blades have a predetermined height.

14. The apparatus of claim 13 wherein said predetermined height of said knockout shapes is randomly selected relative to the predetermined height of said plurality of said knife blades.

15. The apparatus of claim 10 wherein said predetermined perimeter of said knife blades defines a latticed, nested pattern.

16. The apparatus of claim 11 wherein said plurality of knockout shapes each include a knockout surface, at least one knockout surface including at least one raised area.

17. The apparatus of claim 11 wherein said plurality of knockout shapes each include a knockout surface, at least one knockout surface including at least one countersunk area.

18. A method for cutting a slab of food product into a predetermined shape, said slab being within a predetermined size range, said method comprising:
moving the slab of food product on a conveyor from an infeed end to an outfeed end;
providing at least one cutting die having plurality of laterally extending knife blades, each knife blade having a predetermined perimeter, the perimeter defining a predetermined cutting pattern, said predetermined cutting pattern having a latticed, nested configuration;
subjecting the slab of food product to the cutting action of said at least one cutting die to cut the slab of food product.

19. The method of claim 18 further including the steps of:
providing a knockout block, said knockout block including at least one countersunk channel arranged to slidably receive at least one of said plurality of knife blades;
moving said at least one cutting die to a position wherein at least one of said plurality of knife blades is received in said countersunk channel, thereby urging said food product of predetermined shape from said cutting die.

20. A food product formed by a cutting die, said cutting die having a latticed, nested cutting configuration; wherein said cutting die is reciprocally movable from a first, normal position to a second, cutting position; and wherein said cutting die is received by a stationary knockout block when in said normal position.
